(19) United States
(12) Patent Application Publication
(10) Pub. No.: US 2004/0246201 A1
(43) Pub. Date: Dec. 9, 2004

(54) OLED display and pixel structure thereof

(76) Inventors: Chih-Feng Sung, Miaoli City (TW); Chun-Huai Li, Pingtung County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/802,286

(22) Filed: Mar. 17, 2004

(30) Foreign Application Priority Data
Jun. 5, 2003 (TW) 92115184

(51) Int. Cl. G09G 3/00; G09G 3/10

(52) U.S. Cl. 345/30

(57) ABSTRACT

An OLED display and pixel structure thereof. The pixel structure comprises a first transistor, a storage capacitor, a second transistor and an OLED. The first transistor has a gate terminal coupled to a scan signal and a drain terminal coupled to a data signal. The storage capacitor has two terminals coupled to a source terminal of the first transistor and a reference node, which has a second voltage. The second transistor has a gate terminal coupled to the source terminal of the first transistor and a source terminal coupled to the reference node. The OLED has a cathode coupled to a drain terminal of the second transistor and an anode coupled to a first voltage, higher than the second voltage. The first transistor or the second transistor is an amorphous silicon thin film transistor (a-Si TFT), and a light efficiency of the OLED is no less than 11 cd/A.

### BACKGROUND OF THE INVENTION

1. Field of the Invention

The present invention relates to an active matrix organic light-emitting diode (OLED) display and in particular to a less costly and easily manufactured active matrix OLED display.

2. Description of the Related Art

Organic light-emitting diodes (OLED) are active lighting elements, which, when receiving a voltage, inject an electron into an organic semiconductor through a cathode, and into an electron hole through an anode. The electron and the electron hole form an electron-hole pair in an organic thin film, and produce photons by radiative recombination.

Compared with a conventional inorganic LED, the OLED is easily formed on large panels. Additionally, displays utilizing OLEDs require no backlight module, such that the manufacturing process is simpler and costs are reduced.

OLEDs can be applied to small panels such as those in personal digital assistants (PDAs) or digital cameras.

In a conventional OLED display, a pixel is formed by two thin film transistors (TFT). The first TFT switches the pixel, and the second TFT controls the power applied to the OLED. Two types of common TFTs are applied to OLED displays, amorphous silicon thin film transistors (a-Si TFTs) and low-temperature Poli-silicon (LTPS) TFTs. The resistance of the a-Si TFT is 10˜100 times that of LTPS TFT, such that, the a-Si TFT produces more heat than the LTPS TFT. High temperature (over 70° C.) is detrimental to the OLED, thus, the LTPS TFT is a better choice for a control element of the active matrix OLED display. Manufacture of the LTPS TFT, however, is very complicated and costly product thus reliability suffers.

### SUMMARY OF THE INVENTION

The pixel structure of the present invention comprises a first transistor, a storage capacitor, a second transistor and an OLED. The first transistor has a gate terminal coupled to a scan signal and a drain terminal coupled to a data signal. The first transistor switches the transmission of the data signal according to the scan signal. The storage capacitor has two terminals coupled to a source terminal of the first transistor and a reference node, which has a second voltage. The second transistor has a gate terminal coupled to the source terminal of the first transistor and a source terminal coupled to the reference node. The OLED has a cathode coupled to a drain terminal of the second transistor and an anode coupled to a first voltage, higher than the second voltage. The first transistor or the second transistor is an amorphous silicon thin film transistor (a-Si TFT), and a light efficiency of the OLED is no less than 11 cd/A.

### BRIEF DESCRIPTION OF THE DRAWINGS

The present invention can be more fully understood by reading the subsequent detailed description and examples with references made to the accompanying drawings, wherein:

FIG. 1a shows the first embodiment of the present invention;

FIG. 1b shows the second embodiment of the present invention;

FIG. 2 shows an experiment result of a current-temperature relationship of a 4 inch display.

### DETAILED DESCRIPTION OF THE INVENTION

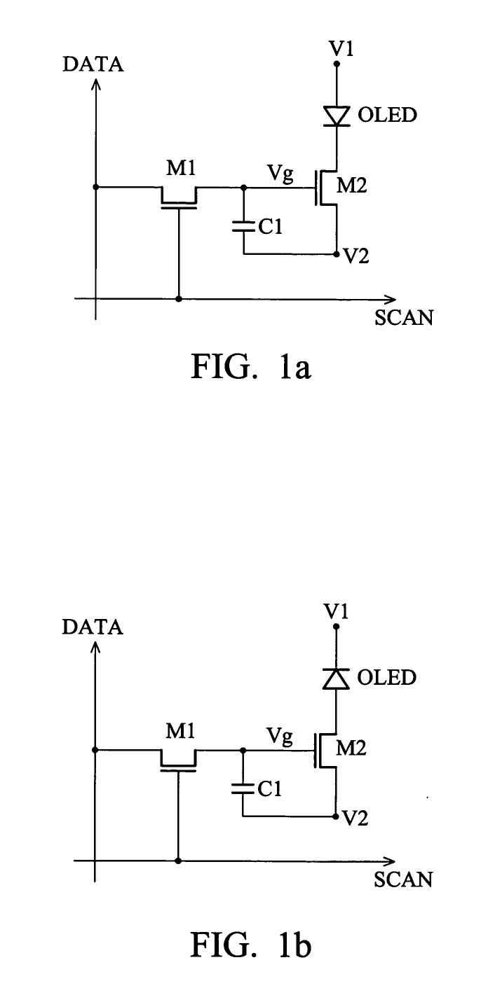

FIG. 1a shows a first example of the present invention. The pixel structure comprises a first transistor M1, a storage capacitor C1, a second transistor M2 and an organic light emitting diode (OLED). The first transistor has a gate terminal coupled to a scan signal SCAN and a drain terminal coupled to a data signal DATA. The first transistor M1 controls the transmission of data signal DATA according to the scan signal SCAN. The storage capacitor C1 has two terminals coupled to a source terminal of the first transistor M1 and a reference node. The reference node has a second voltage V2. The second transistor M2 has a gate terminal coupled to the source terminal of the first transistor M1 and a source terminal coupled to the reference node. The OLED has a cathode coupled to a drain terminal of the second transistor M2 and an anode coupled to a first voltage V1. The first voltage V1 exceeds the second voltage V2. The second transistor controls the current through the OLED according to the data signal DATA. The first transistor M1 or the second transistor M2 is an amorphous silicon thin film transistor (a-Si TFT), and a light efficiency of the OLED is no less than 11cd/A.

The second voltage V2 can be a ground or a low voltage.

The first voltage V1 can be a power supply voltage.

FIG. 1b shows a second embodiment of the present invention, wherein, the OLED is connected to the source terminal of the second transistor M2 via the anode, and connected to the first voltage V1 via the cathode. The drain terminal of the second transistor M2 is connected to the reference node. The second voltage V2 exceeds the first voltage V1.

When a voltage of the scan signal SCAN received by the gate terminal of the first transistor M1 is higher than an active voltage of the first transistor M1, the first transistor M1 transmits the data signal DATA to the storage capacitor C1. Then, when a stored voltage Vg in the storage capacitor C1 is higher than an active voltage of the second transistor M2, the second transistor M2 transmits an actuation current through the OLED according to the stored voltage Vg. Thus, brightness of the OLED is controlled by the data signal DATA.

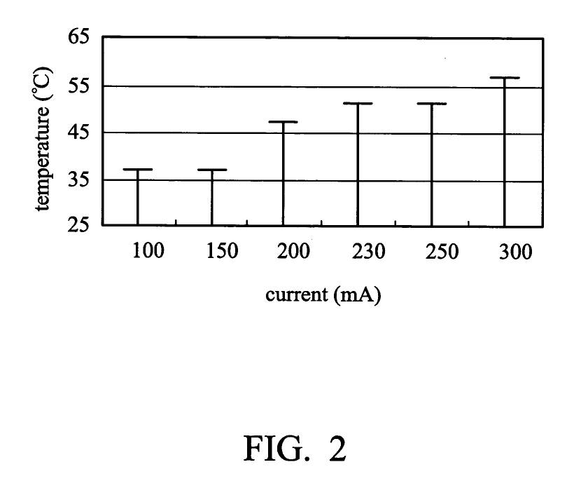

FIG. 2 shows a current-temperature relationship of a 4 inch display with a display resolution of 160(RGB)*234 dpi. The current requirement increases with an increase in display brightness. When a current passed by the display increases to 200 mA, the temperature of the a-Si TFT increases suddenly. Thus, if the current passed by the display can be maintained under 200 mA, the a-Si TFT can be employed in an OLED display.

When a 200 mA current passes through the entire display, a 200 mA/(160*3*234)=1.78 μA current passes through each pixel. The lighting area of each pixel is 1.94*10⁻⁴cm². Thus, a current density of each pixel is J=9.17 mA/cm². If a-Si TFTs are employed in the OLED display, the current density of the a-Si TFTs must be less than 9.17 mA/cm² Considering the lighting function of the OLED:

$$\begin{matrix}EF = \frac{B \times A}{I} = \frac{B}{10 \times J} \\ J = \frac{B}{10 \times EF} < 9.17 mA \text{/} cm 2 \\ EF ( cd \text{/} A ) > \frac{B}{91.7}\end{matrix}$$

EF is the light efficiency of the OLED, B is brightness, A is lighting area, I is current, and J is current density.

Therefore, if the brightness requirement of the active matrix OLED display is 1000 cd/m², the light efficiency of the OLED must exceed 11 (cd/A). Utilizing OLEDs with a light efficiency of over 11(CD/A), prevents the superheating of a-Si TFTs.

The OLED can be made of C545T (10-(2-Benzothiazolyl)-1,1,7,7,-tetramethyl-2,3,6,7-tetrahydro-1H, 5H,11H-[1]benzopyrano[6,7,8-ij]quinolizin-11-one) which has a light efficiency of about 12˜15 cd/A, or Irppy (fac-tris(2-phenylpyridine′)iridium) which has a light efficiency of about 20˜28 cd/A.

The present invention utilizes a less complex TFT to control the signal of the active matrix OLED display, reducing costs thereof.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A pixel structure of an active matrix organic light emitting diode (OLED) display, comprising:
a first transistor having a gate terminal coupled to a scan signal and a drain terminal coupled to a data signal, the first transistor switching the transmission of the data signal according to the scan signal;
a storage capacitor having two terminals coupled to a source terminal of the first transistor and a reference node, the reference node having a second voltage;
a second transistor having a gate terminal coupled to the source terminal of the first transistor and a source terminal coupled to the reference node; and
an OLED having a cathode coupled to a drain terminal of the second transistor and an anode coupled to a first voltage exceeding the second voltage;
wherein the first transistor or the second transistor is an amorphous silicon thin film transistor (a-Si TFT), and a light efficiency of the OLED is no less than 11 cd/A.

2. The pixel structure as claimed in claim 1, wherein the OLED is made of C545T.

3. The pixel structure as claimed in claim 1, wherein the OLED is made of Irppy.

4. The pixel structure as claimed in claim 1, wherein the second voltage is a ground.

5. An active matrix organic light emitting diode (OLED) display, comprising:
a panel, comprising a plurality of pixels, each pixel comprising a first transistor having a gate terminal coupled to a scan signal and a drain terminal coupled to a data signal, the first transistor switching the transmission of the data signal according to the scan signal; a storage capacitor having two terminals coupled to a source terminal of the first transistor and a reference node, the reference node having a second voltage; a second transistor having a gate terminal coupled to the source terminal of the first transistor and a source terminal coupled to the reference node; and an OLED having a cathode coupled to a drain terminal of the second transistor and an anode coupled to a first voltage, the first voltage exceeding the second voltage; wherein the first transistor or the second transistor is an amorphous silicon thin film transistor (a-Si TFT), and a light efficiency of the OLED is no less than 11 cd/A.

6. The pixel structure as claimed in claim 5, wherein the OLED is made of C545T.

7. The pixel structure as claimed in claim 5, wherein the OLED is made of Irppy.

8. The pixel structure as claimed in claim 5, wherein the second voltage is a ground.

9. A pixel structure of an active matrix organic light emitting diode (OLED) display, comprising:
a first transistor having a gate terminal coupled to a scan signal and a drain terminal coupled to a data signal, the first transistor switching the transmission of the data signal according to the scan signal;
a storage capacitor having two terminals coupled to a source terminal of the first transistor and a reference node, the reference node having a second voltage;
a second transistor having a gate terminal coupled to the source terminal of the first transistor and a drain terminal coupled to the reference node; and
an OLED having an anode coupled to a source terminal of the second transistor and a cathode coupled to a first voltage less than the second voltage;
wherein the first transistor or the second transistor is an amorphous silicon thin film transistor (a-Si TFT), and a light efficiency of the OLED is no less than 11 cd/A.

10. The pixel structure as claimed in claim 9, wherein the OLED is made of C545T.

11. The pixel structure as claimed in claim 9, wherein the OLED is made of Irppy.

12. The pixel structure as claimed in claim 9, wherein the second voltage is a high voltage.

13. An active matrix organic light emitting diode (OLED) display, comprising:
a panel, comprising a plurality of pixels, each pixel comprising a first transistor having a gate terminal coupled to a scan signal and a drain terminal coupled to a data signal, the first transistor switching the transmission of the data signal according to the scan signal; a storage capacitor having two terminals coupled to a source terminal of the first transistor and a reference node, the reference node having a second voltage; a second transistor having a gate terminal coupled to the source terminal of the first transistor and a drain terminal coupled to the reference node; and an OLED having an anode coupled to a source terminal of the second transistor and a cathode coupled to a first voltage less than the second voltage; wherein the first transistor or the second transistor is an amorphous silicon thin film transistor (a-Si TFT), and a light efficiency of the OLED is no less than 11 cd/A.

14. The pixel structure as claimed in claim 13, wherein the OLED is made of C545T.

15. The pixel structure as claimed in claim 13, wherein the OLED is made of Irppy.

16. The pixel structure as claimed in claim 13, wherein the second voltage is a high voltage.
